(19) United States
(12) Patent Application Publication
(10) Pub. No.: US 2024/0309180 A1
(43) Pub. Date: Sep. 19, 2024

(54) Dry Starch Used in Field of Biodegradable Plastics, and Preparation Method and Use Thereof

(71) Applicants: Yifan LIU, Shandong (CN); SHANDONG YUSHI BIOTECHNOLOGY CO., LTD, Shandong (CN)

(72) Inventor: Yifan Liu, Shandong (CN)

(21) Appl. No.: 18/576,951

(22) PCT Filed: Jul. 11, 2022
(86) PCT No.: PCT/CN2022/104930

§ 371 Date: Jan. 5, 2024

(30) Foreign Application Priority Data
Jul. 12, 2021 (CN) 202110792308.4
Oct. 15, 2021 (CN) 202111212855.7

(51) Int. Cl. C08L 3/02; C08B 30/06; C08J 3/12

(52) U.S. Cl. CPC C08L 3/02; C08B 30/06; C08J 3/12; C08J 2303/02; C08L 2201/06; C08L 2310/00

(57) ABSTRACT

Disclosed are a dry starch used in a field of biodegradable plastics, and a preparation method and use thereof. The dry starch used in a field of biodegradable plastics is prepared by removing moisture from a commercial starch, wherein the dry starch has a moisture content of not greater than 5 wt %; and starch granules have an internal organizational structure mainly in an amorphous form.

### CROSS REFERENCE TO RELATED APPLICATION

The present application is a national stage application of International Patent Application No. PCT/CN2022/104930, filed on Jul. 11, 2022, which claims priority to Chinese Patent Application No. 202110792308.4 filed with the China National Intellectual Property Administration (CNIPA) on Jul. 12, 2021 and entitled “METHOD FOR PREPARING STARCH FOR PLASTICS AND USE THEREOF”, and Chinese Patent Application No. 202111212855.7 filed with the China National Intellectual Property Administration (CNIPA) on Oct. 15, 2021 and entitled “DRY STARCH USED IN FIELD OF BIODEGRADABLE PLASTICS”. The disclosures of the three applications are incorporated herein by reference in their entireties.

### TECHNICAL FIELD

The present disclosure relates to the technical field of plastic raw materials, and in particular to a dry starch used in a field of biodegradable plastics, and a preparation method and use thereof.

### BACKGROUND

With the improvement of environmental requirements and the implementation of environmental policies, for plastic products, the use of biodegradable plastics is mandatory for many products in the field of packaging materials and disposable plastic products. Currently, the mature biodegradable plastics on the market include polylactic acid (PLA), dibasic acid-diol copolyesters (such as poly(butylene adipate-co-terephthalate) (PBAT) and poly(butylene) succinate (PBS)), polyhydroxyalkanoates (PHAs). However, due to limitations in techniques and processes, prices of products such as PLA, PBAT, and PHA far exceed those of petroleum-based plastics. Therefore, during production, a specified amount of a corn starch, a tapioca starch, a wheat starch, or the like is often added to biodegradable plastics such as PLA and PBAT to reduce production costs and increase competitiveness. The existing process for adding starch usually involves directly mixing the starch with a biodegradable resin such as PLA in a device, and then subjecting the resulting mixture to subsequent processing. Due to the different compositions and structures of starch and biodegradable resin, the performance of the biodegradable resin will be heavily reduced after the starch is added, which limits the amount of starch added during the preparation of a biodegradable plastic product.

A commercial starch (using a commercial corn starch as an example, the same below) has a moisture content of about 13%. It has been demonstrated by techniques and processes that moisture is an excellent plasticizer for a starch. As a result, in many of the existing techniques, a certain amount of moisture is often retained in a starch to facilitate the acquisition of a plasticized starch (PLS). However, the present applicant has found through research that the addition of a starch leads to a degradation of the mechanical performance and processing performance of a biodegradable resin such as PLA and PBAT, and a very important factor in the degradation of performance is the moisture in the starch itself. Because a part of the moisture in a starch forms a hydrogen bond with hydroxyl in the starch and exists in the form of bound water, it is difficult to further remove moisture from a starch when the moisture content in the starch drops to a certain value (such as 13%).

### SUMMARY

In order to solve the above-mentioned technical problems, the present disclosure provides a dry starch used in a field of biodegradable plastics, and a preparation method and use thereof.

The present disclosure is realized by the following technical solutions:

A method for preparing a dry starch used in a field of plastics (a technical solution 1), including:
step (1) mixing water with a starch to obtain a mixture, an amount of the water added meeting that a moisture content accounts for between 15 wt % and 30 wt % of a total weight of the mixture;
step (2) puffing the mixture obtained in step (1) with a puffing machine to obtain a starch puffing body;
step (3) drying the starch puffing body to a moisture content of less than 6% to obtain a dried starch puffing body; and
step (4) crushing the dried starch puffing body obtained in step (3) into a powder having a fineness degree of not less than 80 mesh to obtain the dry starch.

A method for preparing a dry starch used in a field of plastics (a technical solution 2), including:
step (1) adding a starch and water simultaneously into a puffing machine to obtain a mixture, an amount of the water meeting that a moisture content accounts for between 15 wt % and 30 wt % of a total weight of the mixture;
step (2) puffing the mixture in the puffing machine to obtain a starch puffing body;
step (3) drying the starch puffing body to a moisture content of less than 6% to obtain a dried starch puffing body; and
step (4) crushing the dried starch puffing body obtained in step (3) into a powder having a fineness degree of not less than 80 mesh to obtain the dry starch.

A method for preparing a dry starch used in a field of plastics (a technical solution 3), including:
step (1) taking a semi-wet starch with a moisture content of between 15 wt % and 30 wt % from a wet-grinding starch-processing procedure;
step (2) puffing the semi-wet starch in a puffing machine to obtain a starch puffing body;
step (3) drying the starch puffing body to a moisture content of less than 6% to obtain a dried starch puffing body; and
step (4) crushing the dried starch puffing body obtained in step (3) into a powder having a fineness degree of not less than 80 mesh to obtain the dry starch.

A method for preparing a dry starch used in a field of plastics (a technical solution 4), including:
step (1) taking a wet starch obtained from a wet-grinding starch-production process, and drying the wet starch to a moisture content of between 15 wt % and 30 wt % to obtain a semi-wet starch;
step (2) puffing the semi-wet starch in a puffing machine to obtain a starch puffing body;
step (3) drying the starch puffing body to a moisture content of less than 6% to obtain a dried starch puffing body; and
step (4) crushing the dried starch puffing body obtained in step (3) into a powder having a fineness degree of not less than 80 mesh to obtain the dry starch.

In some embodiments, in step (3), the drying is conducted by hot air drying.

In some embodiments, in step (4), the dry starch has a particle size of greater than 100 mesh.

The dry starch prepared in any of the above technical solutions is melt-mixed with a plastic masterbatch in a granulator to obtain a starch-based plastic masterbatch, wherein a mass percentage of the dry starch is between 3% and 70% without the addition of a starch plasticizer.

The dry starch prepared in any of the above technical solutions is melt-mixed with a plastic masterbatch in a molding machine to obtain a starch-based plastic product, wherein a mass percentage of the dry starch is between 3% and 70% without the addition of a starch plasticizer.

In some embodiments, step (3) is interchanged with step (4), such that the starch puffing body is crushed into a starch powder having a fineness degree of not less than 80 mesh and then the starch powder is dried to a moisture content of less than 6%.

The dry starch prepared in the above technical solution is melt-mixed with a plastic masterbatch in a molding machine to obtain a starch-based plastic product, wherein a mass percentage of the dry starch is between 3% and 70% without the addition of a starch plasticizer.

Compared with the prior art, the theoretical basis and innovativeness of the present disclosure are as follows:

In a first aspect, the removal of moisture adopts the technical idea of retreating in order to advance.

One of the objects of the present disclosure is to reduce the moisture content in an ordinary starch to obtain a dry starch. However, the first step in the solution of the present disclosure is to make the moisture in the starch exceed that of a commercial starch. Additional water is added to the starch for the following reasons:

1. The additional water can serve as a processing aid and a plasticizer for the starch. Commercial starch is a powder with a moisture content generally of between 13% and 14%. When the starch is added into a puffing machine, if the moisture content of the starch is lower (such as less than 15%), the screw of the puffing machine will slip and cannot be pushed forward; if the moisture content of the starch increases, due to the cohesive effect of moisture on the starch granules, the screw can be promoted to drive the starch to move towards the next stage, so as to prevent the screw from slipping, in which the starch plays a role of a processing aid.

In addition, although the starch is subjected to extrusion and high temperature in the screw cavity of the puffing machine, the working conditions of the puffing machine cannot change the rigid and solid state of the starch. Water can plasticize the starch under these conditions, thereby transforming the starch from rigid to flexible and from solid to fluid. At this time, the water acts as a plasticizer. A higher moisture content means a better plasticizing effect, but may affect screw feeding. Therefore, it is generally required that the moisture content therein should not be less than 15% when plasticizing commercial starch. Of course, if the added starch has a too-high moisture content, such as more than 40%, this may cause the starch to stick to the screw and the extruder cavity when it is added into the puffing machine, and the starch may be plasticized into a less viscous liquid at the rear of the extruder, which is not conducive to processing. According to the experiments, when the moisture content in the starch reaches 15%, the starch can be extruded and puffed in an extruder; when the moisture content is between 18% and 25%, there is a better processing effect; but when the moisture content exceeds 30%, the processing conditions of the starch become increasingly worse due to high humidity. Therefore, the amount of water added can be controlled based on the processing technology. On the other hand, when the moisture content of the starch is lower, the melting temperature of the starch will be higher, which is not conducive to full plasticization of the starch.

2. The additional water can serve as a puffing agent for the starch. One technical means of the present disclosure is to puff the starch, and water just acts as a puffing agent. Experiments have proven that when the moisture content in the starch is 13%, the starch can be puffed in the puffing machine, and a higher moisture content means a better puffing effect. However, taking into account the plasticization requirements of the starch and cost factors, the moisture content of the starch is generally selected to be between about 18% and 22%.

In a second aspect, the starch is dried in a puffed state, which can overcome the shortcomings of the existing technology and easily remove the moisture content in the starch.

1. The existing commercial starch has a moisture content of about 13%. The applicant has found that water exists in two states in the starch: one is free water, and there is a loose combination between the free water and the starch molecules. During drying, the free water can be more easily dried out of the starch. The other one is bound water, which is characterized by a fixed hydrate formed by the combination of water and starch molecules in the form of a hydrogen bond. When ordinary starch is dried, the bound water is difficult to separate from the starch due to the effect of the hydrogen bond, unless large amounts of additional energy are expended. When the moisture content in existing starch is reduced to 13%, it is difficult to continue to remove water due to the influence of the bound water.

2. After the starch is puffed, the moisture becomes easy to remove. The reason for this is that, as mentioned above, the starch may exist in the form of fluffy, porous lumps after exiting the puffing machine. Compared with powdered starch, this form can help to evaporate the moisture in the starch and help to deeply dry the starch by relying on existing drying methods. The applicant has further found that the bound water mainly exists in the crystallization region of the starch granules, while the free water mainly exists in the amorphous region. When the starch is extruded and heated in a puffing machine, the crystalline state of its crystalline part transforms into an amorphous form. In this way, the bound water is converted into free water, which can be easily removed from the starch by existing drying means. This is also a key mechanism of the solutions of the present disclosure. In addition, when the amorphous starch and the moisture contained thercin pass through the die of the puffing machine, the moisture can instantly transform into gas under the action of high temperature and high pressure, and most of which may evaporate instead of continuing to exist in the starch. At the same time, when the moisture changes from liquid to gas, the starch expands, and transforms into a porous and fluffy solid block form, both inside and outside. This form is very conducive to the removal of the moisture from the starch again through the drying device. As a result, although moisture is added to the starch at the beginning of processing, it is easier to remove the moisture from the starch through extrusion, puffing, and drying. Furthermore, the drying operations for starch in a block form are simpler, and compared with ordinary starch in a powder form, starch blocks are less likely to catch fire and even less likely to cause dust explosions during drying.

In a third aspect, after being puffed and dried, the starch has a low moisture content and a strong brittleness, and is easily refined to obtain a starch with a high fineness degree.

As mentioned above, the dry starch has a low moisture content, and the internal organizational structure of the starch is amorphous rather than crystalline, and there are puffed pores after puffing. These factors determine that the dry starch is very easy to crush. The dry starch can be refined to a particle size of more than 150 mesh by spending less time and electrical energy in a micronizer. Under the same conditions, commercial starch cannot be refined to the same mesh size in the micronizer. Research has shown that there is no starch in the current starch products which is more than 150 mesh. Dry starch in an ultra-fine micronizer can also achieve a mesh size of not less than 300, which cannot be achieved on the commercial starch. This is also one of the features that distinguishes the present disclosure from the prior art.

In a fourth aspect, the dry starch is a novel applied material.

The applicant defines the dry starch as: having a moisture content of less than 6%, preferably not more than 5%, a fineness degree of the starch granules of not less than 100 mesh after being puffed by a puffing process, and an internal organizational structure of the starch granules being mainly amorphous and non-crystalline.

In a fifth aspect, the present disclosure adopts technical routes and means that are different from those in the prior art when applying the dry starch of a field of plastics, especially in a field of biodegradable plastics.

In the prior art, when the starch is applied to plastic products, the starch is plasticized under the action of a plasticizer, and then mixed with other plastic raw materials to obtain a starch-based plastic product. In the process, the choice of a plasticizer is an essential technical means. For example, patents CN111548536A, CN103992517B, CN104448402A, and U.S. Pat. No. 7,608,649B2 all adopt a combination of the plasticizer, the starch, and a plastic resin.

For starch, plasticizers are mainly alcohols with hydroxyl groups and smaller molecular weights or amines with amino groups and smaller molecular weights. As disclosed in patent CN103992517B, the plasticizers used include water, glycerol, formamide, sorbitol, and low-molecular-weight polyethylene glycol. In addition, some technologies disclose urea, methylamine, ethylamine, etc are used as the plasticizers for starch. Both alcohols and amines are highly polar molecules. Starch can only be melted and plasticized at higher temperatures under the action of the strong polar molecules mentioned above. However, while plasticizing starch, the plasticizers may also cause a deterioration in the performance of the plastic resins mixed with the same, such as PBAT and PLA. Even if mixed with traditional plastics such as polypropylene (PP) and PE, the plasticizers may also cause a deterioration in the performance of PP and polyethylene (PE).

Starch plasticizers can adversely affect the performance of starch-based products.

The following table shows the mechanical properties of dry starch, glycerol, and PBAT after melt-mixing. The starch is made according to the present disclosure, having a moisture content of 3% and a fineness degree of 150 mesh; a mass ratio of the starch to the PBAT is 20:80; and a glycerol percentage is determined according to a mass of the starch.

TABLE 1

| Glycerol content | 0 | 5% | 10% | 20% | 30% | 40% |
|---|---|---|---|---|---|---|
| Tensile strength MPa | 21.4 | 20.7 | 18.3 | 16.7 | 14.6 | 13.8 |
| Elongation % | 189 | 181 | 167 | 153 | 141 | 127 |

As shown in Table 1, as the glycerol content increases, both the tensile strength and the elongation of the material show a downward trend. That is, the glycerol as a plasticizer has a deteriorating effect on the material properties. In addition, experiments have shown that the glycerol can plasticize starch; when the glycerol content reaches 20% of the starch, all the starch can be plasticized. In this way, while plasticizing the starch, the glycerol also causes a deteriorating effect on the mechanical properties of the final material. The material has the best mechanical properties when the glycerol content is 0.

Other experiments have shown that, in addition to the glycerol, the starch plasticizers such as urea and ethylene glycol have basically similar effects on materials.

Experiments have also shown that the changes in properties after the melt-mixing of starch, glycerol, PP, and PE are similar to the above melt-mixing of starch, glycerin, and PBAT. That is, the starch plasticizers generally have a deteriorating effect on the material alloy when the starch is added to plastics.

Therefore, the two technical solutions for the application of dry starch involved in the present disclosure both abandon the use of the starch plasticizers, and allow the starch to be directly combined with plastic resins such as PBAT, so that the alloy materials have better mechanical properties.

The patents CN111548536A, CN103992517B, CN104448402A, and U.S. Pat. No. 7,608,649B2 all use starch plasticizers, so the technical routes of the present disclosure are obviously different from the existing technology in a field of starch-based degradable materials. The advantages of the present disclosure are that the alloy material has better mechanical properties, saves the expense and process of plasticizer, and reduces cost. More importantly, the technical solutions of the present disclosure can solve the two major problems that currently plague the existing technology, namely plasticizer precipitation and starch retrogradation: without plasticizer, of course, there can be no problem of plasticizer precipitation; and a moisture content of dry starch is much lower than that of a commercial starch (13%), which can solve the problem of retrogradation in starch-based plastic products.

Each of the technical solutions will be further described and explained below:

### I. Amount of Water Added Before Starch Puffing

A difference between the technical solution 1, the technical solution 2, the technical solution 3 and the technical solution 4 lies in a difference in step (1), and the difference in step (1) lies in a mixing mode of water and the starch. However, a same requirement is that the starch must have a certain moisture content before puffing, that is, the moisture content in the starch must reach a range of 15 wt % to 30 wt %.

The wet starch in technical solution 4 is taken from a starch production process. At present, starch production in China and the United States mainly adopts wet grinding technology, referring to reference “Corn Starch Engineering Technology” published by China Light Industry Press and edited by BAI Kun. In the reference, the dehydration link in the production process is described as follows: a starch is separated by a scraper centrifuge to obtain a wet starch and a filtrate, wherein the wet starch has a moisture content of approximately 38%; and the drying link is described as follows: the wet starch enters a drying tube in an airflow drying system, and the moisture inside and outside starch granules is removed to obtain a commercial starch, wherein the commercial starch has a moisture content of less than or equal to 14%.

The semi-wet starch in technical solution 3 is a starch directly taken from the drying link in the starch processing process and is not a commercial starch. Specifically: when entering the airflow drying system for drying, the wet starch does not need to be dried to a moisture content of less than or equal to 14%, but only to a moisture content of 15% to 30%. This can not only reduce drying costs, but also allow the semi-wet starch to be used directly in the present disclosure.

The semi-wet starch in technical solution 4 is prepared by drying a wet starch purchased from a starch factory in a drying device outside the starch factory to a moisture content of between 15% and 30%.

The reason for the moisture content of between 15% and 30% has already been explained. In the specific process, the manner in which water is added to the starch can be determined based on actual conditions. The moisture content in the process must be determined in conjunction with the puffing process. If the puffing machine works at a higher speed, the moisture content of the wet starch can be lower, such as not more than 18%, but it is best not to be below 15%. If the puffing machine works at a lower speed, the moisture content of the wet starch can be higher. For example, if the puffing machine works at 50 r/h and the moisture content of the wet starch reaches 30%, puffing can still be conducted in a single-screw extruder.

### II. Puffing of the Starch

In step (2) of the technical solution 1, the technical solution 2, the technical solution 3, and the technical solution 4, the starch puffing body is a starch solid obtained by puffing a starch having a specified moisture content (15 wt % to 30 wt %) by a puffing machine. The term puffing is defined as: the starch is melted and plasticized in the puffing machine under the action of water and a certain temperature, pressure is generated during the rotation of a screw of the puffing machine, then the moisture in the PLS is vaporized due to sudden decompression when the PLS exits a die of the puffing machine, and the PLS expands in volume and forms a porous solid.

After the puffing, the starch produces two effects:

First, the existence state of the starch has changed: after puffing, the starch changes from a powdery to a porous and fluffy block. Compared with powder, the fluffy and porous form is highly conducive to the drying of the starch.

Second, the structure of the starch has changed: some data reveal that starch granules are composed of a crystallization region and an amorphous region. The applicant have found that when the starch is used in the plastic field, the two regions have different influences on the properties of the final starch product.

The amorphous region, due to its disordered arrangement, is beneficial to the plasticization process of the starch and the plasticity of the products. As for the crystallization region, due to the existence of crystals, it is not conducive to the plasticization processing of the starch. From a technological perspective, reducing the content of the crystallization region in starch granules will facilitate the plasticization processing of the starch. Based on this, when starch is puffed, under the high temperature and high pressure of the puffing machine and the plasticizing action of water as a plasticizer, the crystalline structure inside the starch granules is broken, which prompts the starch to change from a crystalline state to an amorphous state. When the starch under this condition exits the puffing machine through the die opening, water acts as a puffing agent, and puffs the starch into porous and loose solid blocks. After analysis, the internal structure of the solid blocks is still in an amorphous state. In short, the internal structure of the starch after puffing can undergo changes that are different from the original starch, which greatly improves the performance of the final product during plasticization and molding.

The puffing machine is a common device, which may be a single-screw, twin-screw, or three-screw extruder with heating configuration and is commonly used in the food and feed fields. Compared with other extruders used in the plastics field, the rotational speed of the puffing machine is slightly higher, with a rough range of 20 rpm to 200 rpm, or higher. The selection of the puffing machine is related to the puffing pressure and the die size required by the process, as well as other parameters of the puffing machine.

The working temperature of the puffing machine must meet the requirements of the puffing, and is generally higher than 110° C. The shape of the starch puffing body can be in its original shape extruded by the puffing machine, such as long strip, and pellet, etc, or can be properly crushed (preferably pre-dried, such as blow-dried by a fan, until the moisture content is less than 15%), into small pieces, chunks, or powders. However, from the perspective of drying convenience in step (3), it is best not to grind the starch puffing body into too fine powder, such as greater than 100 mesh. If the mesh number is too high, the porosity of the starch puffing body will be reduced, which is not conducive to subsequent drying.

### III. Drying of the Starch Puffing Body

As mentioned above, the appearance of the starch puffing body coming out of the puffing machine is solid, in the form of strips, blocks, and granules, etc. Therefore, more flexible drying modes, such as hot air drying, can be used for drying the starch puffing body, which is also a drying mode that cannot be adopted for ordinary starch. An embodiment of the present disclosure is to adopt hot air drying, that is, to directly dry a solid starch puffing body through hot air. The hot air is generally generated by a hot air blower. In view of the reaction of starch molecules to heat, the temperature of the hot air may be selected within a range of 80° C. to 150° C. If the temperature is too low, drying will take a long time. If the temperature is too high, the starch molecules are easily carbonized. A more suitable temperature is in a range of 100° C. to 120° C. Since the starch puffing body is a porous bulk solid, the drying method can not only achieve the drying effect, but also prevent dust pollution during the drying. Other modes such as oven drying, vacuum drying, and microwave drying are also fully applicable to the drying of starch puffing body. Moreover, when these drying modes are adopted, since the starch puffing body has a porous and fluffy shape compared to ordinary starch, the moisture in the starch is easier to volatilize and remove. Modes such as hot air drying, oven drying, and vacuum drying are all conventional operating methods.

Table 2 shows the drying data (drying time and moisture content) of a corn commercial starch and a puffed starch puffing body thereof in a same dryer, wherein the starch puffing body has a particle size of 1 mm to 2 mm; both starting masses are 100 g; the dryer works at 120° C.; and the moisture content of starch is in mass percentage (%).

TABLE 2

| Time (min) | 0 | 15 | 20 | 30 | 40 | 70 |
|---|---|---|---|---|---|---|
| Commercial starch | 13.15 | 10.67 | 8.21 | 6.34 | 5.27 | 2.41 |
| Starch puffing body | 12.54 | 5.94 | 3.69 | 1.46 | 0.62 | 0.12 |

Experimental data show that compared with commercial starch, the moisture of the starch puffing body can be removed to not less than 50% in 15 min, while the commercial starch takes nearly twice as long to achieve the similar effect. This indicates that the moisture in the starch after puffing is extremely easy to remove by drying and the drying effect can be achieved in a short time, thus greatly reducing the drying cost.

In another embodiment of the present disclosure, the starch puffing body is crushed into powder and then dried. Compared with drying before powdering, the energy cost of drying after powdering is higher. The reason for this is that the powdery granules block the heat transfer and moisture evaporation between each other. Even so, compared with commercial starch, the puffed powder still has the advantage of less time and low energy during the drying. The reason for this is that after puffing, no matter how small the granules are, there are still puffed pores inside that are highly conducive to drying. More importantly, starch and water molecules in the starch puffing body do not exist in the form of bound water, making it easy to remove water molecules from the inside of the starch granules.

The moisture in the starch puffing body or dry starch must be dried to less than 6% because the moisture content may affect the performance of the plastic alloy. Moreover, if the moisture content is higher, the material alloy will occur retrogradation phenomenon.

Moisture can cause reduce the performance of starch-based products.

Table 3 shows the properties of the material alloys formed by 80% of PBAT and 20% of the dry starch with different moisture contents:

TABLE 3

| Moisture content | 0 | 1% | 2% | 3% | 5% | 6% | 13% |
|---|---|---|---|---|---|---|---|
| Tensile strength MPa | 21.4 | 21.1 | 20.7 | 18.4 | 18.1 | 16.8 | 11.4 |
| Elongation % | 189 | 189 | 184 | 177 | 171 | 163 | 105 |
| Retrogradation | None | None | None | Tiny | Light | Relatively | Obvious |
| phenomenon | | | | | | obvious | |

As shown in Table 3, as the moisture content in the starch increases, the mechanical properties of the material alloy gradually decrease. In addition, if the moisture content in the starch is less than 3%, the material alloy will not occur retrogradation phenomenon. If the moisture content in the starch reaches 6%, the material alloy will occur retrogradation and embrittlement phenomena. Therefore, in each technical solution of the present disclosure, the dry starch is required to have a moisture content of less than 6%, and more preferably, the moisture content is less than or equal to 5%.

### IV. Crushing the Starch Puffing Body to an Appropriate Mesh Number.

Compared with the prior art, one of the technical requirements of the present disclosure is to refine the dry starch to a certain mesh number. The requirement for a higher mesh number for the starch is because the starch does not undergo plasticization when combined with other plastic resins to form an alloy, which is different from the prior art. In this way, the size of the starch particles affects the performance of the alloy (under the premise that the starch has a low moisture content), and a lower fineness degree means a better performance.

Table 4 shows an influence of the fineness degree of the dry starch on performance (PBAT 80%; special starch 20%; starch moisture content 1%):

TABLE 4

| Fineness degree of starch (mesh) | 50 | 80 | 100 | 150 | 250 |
|---|---|---|---|---|---|
| Tensile strength MPa | 15.3 | 18.1 | 20.6 | 21.4 | 24.7 |
| Elongation % | 132 | 154 | 175 | 189 | 213 |

As shown in Table 4, as the mesh number increases, the mechanical properties of the starch and plastic resin become better. When the mesh number of the dry starch reaches 80 mesh, the tensile strength of the alloy is equal to the strength of PBAT itself. When the mesh number reaches 100, the strength of the alloy exceeds the tensile strength of the PBAT resin itself (approximately 18 MPa to 20 MPa). In addition, from the appearance of the obtained material alloy, a higher mesh number means a higher smoothness. Therefore, the starch mesh number in the present disclosure is required to reach 80 mesh, preferably exceeding 100 mesh.

### V. Use of the Dry Starch

When starch is applied in the field of plastics, especially in the field of degradable plastics, the technical route used in the present disclosure is different from that of the prior art, that is, the technical route used is conducted by refining starch instead of plasticizing starch. The prerequisite for using this route is to reduce the moisture content of the starch as much as possible. The dry starch provided by the present disclosure is prepared for this purpose.

When the dry starch is used, a processing method is conducted in which the dry starch is directly mixed with a plastic masterbatch and then fed into a plastic molding machine, or the dry starch and the plastic masterbatch are added to the plastic molding machine at the same time. The processing method is basically the same as the current method of adding calcium carbonate powder to plastics. Sometimes for the convenience of processing, a small amount of processing aids, such as paraffin, may be added.

The plastic masterbatch may be biodegradable plastics such as PLA, PBAT, and polyhydroxyalkanoates (PHA), or traditional petroleum-based plastics such as PP, PE, polyvinyl chloride (PVC), and polyethylene terephthalate (PET).

When the dry starch forms an alloy with the biodegradable plastics such as PLA, PBAT, and PHA, a plastic product obtained by using this alloy is a fully biodegradable plastic product; when the dry starch forms an alloy with the petroleum-based plastics such as PP, PE, PVC, and PET, a plastic product obtained by using this alloy is a partially biodegradable plastic product.

Since the dry starch is a recyclable material with low cost, as long as starch is added to plastics, the functions of reducing carbon emissions and product costs can be realized. Furthermore, since without the addition of a starch plasticizer, the mechanical properties of the alloy will not be affected by the weakening of the starch plasticizer, which also plays an effect on improving the performance of the material virtually.

In practical applications, the addition amount of the dry starch may be determined according to different plastic types, different degradation requirements, product functions and other requirements. For disposable degradable plastic products, the specific addition amount for plastics is generally in a range of 10% to 30%. If the addition amount is small, the advantages of starch cannot be reflected, but if the addition amount of starch exceeds 30%, the properties such as plasticity and toughness of the alloy formed by starch with PBAT and PLA will not meet the requirements.

When the dry starch is applied to boards, the dry starch may have a larger addition amount. For example, 50% starch may be combined with PP to make a starch plastic board, and the processing technology and use thereof are similar to those of commercial wood-plastic boards. However, if the starch content exceeds 70%, it will lead to the existing processing equipment and technology will not be able to work, so Therefore, the present disclosure requires that the maximum amount of the dry starch added to the alloy should not exceed 70%.

Even if a smaller amount of the dry starch is added to the plastic masterbatch, the dry starch can also have a strengthening effect. Experiments show that when 3% of the dry starch with a moisture content of 1% and a mesh number of 250 is added to PE, the tensile strength of the PE can be increased by about 23%.

Compared with the prior art, the present disclosure has the following advantages:
1. The present disclosure provides a dry starch, a new type of material that has never appeared in the market.
2. In the present disclosure, the use of the dry starch in plastics can improve material properties and reduce carbon emissions.
3. The present disclosure overcomes technical prejudice and does not add starch plasticizer in the preparation of starch-based plastic products, resulting in the products have better performance and lower cost.
4. The present disclosure solves the problems of plasticizer precipitation in the existing degradable plastics technology and the retrogradation of starch-based products.

The present disclosure provides a dry starch used in a field of biodegradable plastics, wherein the dry starch is prepared by removing moisture from a commercial starch; the dry starch has a moisture content of not greater than 5%; and starch granules have an internal organizational structure mainly in an amorphous form.

In some embodiments, the dry starch is prepared by a process including:
step (1) preparing a semi-wet starch: adding water to a starch to obtain a semi-wet starch, an amount of the water added meeting that a moisture content accounts for between 15 wt % and 30 wt % of a total weight of the mixture;
step (2) preparing a starch puffing body: puffing the semi-wet starch in a puffing machine to obtain a starch puffing body; and
step (3) preparing the dry starch: drying and crushing the starch puffing body to a moisture content of not greater than 5 wt % to obtain the dry starch.

In some embodiments, the dry starch is prepared by a process including:
step (1) adding a starch and water simultaneously into a puffing machine to obtain a mixture, an amount of the water added meeting that a moisture content accounts for between 15 wt % and 30 wt % of a total weight of the mixture;
step (2) puffing the mixture of the starch and the water obtained in step (1) by a puffing machine to obtain a starch puffing body; and
step (3) drying and crushing the starch puffing body to a moisture content of not greater than 5 wt % to obtain the dry starch.

In some embodiments, the dry starch is prepared by a process including:
step (1) taking a semi-wet starch with a moisture content of between 15 wt % and 30 wt % from a wet-grinding starch-processing procedure;
step (2) puffing the semi-wet starch in a puffing machine to obtain a starch puffing body; and
step (3) drying and crushing the starch puffing body to a moisture content of not greater than 5% to obtain the dry starch.

In some embodiments, the dry starch is prepared by a process including:
step (1) taking a wet starch obtained from a wet-grinding starch-production process, and drying the wet starch to a moisture content of between 15 wt % and 30 wt % to obtain a semi-wet starch;
step (2) puffing the semi-wet starch in a puffing machine to obtain a starch puffing body;
step (3) drying and crushing the starch puffing body to a moisture content of not greater than 5% to obtain the dry starch.

In some embodiments, the dry starch is prepared by drying a commercial pregelatinized starch to a moisture content of not greater than 5%.

In some embodiments, the dry starch is prepared by drying the commercial starch in a microwave dryer to a moisture content of not greater than 5%.

In some embodiments, the dry starch is prepared by subjecting the commercial starch to heat-drying under extrusion and shearing in a device capable of providing an extrusion force and a shearing force to a moisture content of not greater than 5%.

In some embodiments, the dry starch has a particle size of greater than 100 mesh.

In some embodiments, the dry starch has a moisture content of not greater than 3 wt %.

Compared with existing technology, the theoretical basis and innovativeness of the technical solutions are as follows:

I. In the present disclosure, the method for preparing the dry starch adopts a different process from the conventional direct drying of starch: the higher the moisture content in the starch, the greater the degradation in product performance. The reason for this is that the moisture not only reduces the compatibility of starch and biodegradable resins such as PLA and PBAT, but also reduces the performance of PLA and PBAT. Therefore, in order to achieve a better combination of starch and biodegradable resin, the moisture content in the starch must be reduced. The lower the moisture content, the more the influence of moisture on the performance of the biodegradable resins is reduced.

The present disclosure adopts a technical idea of “retreating before forwarding”:

An object of the present disclosure is to reduce the moisture content in an ordinary starch to obtain a dry starch. However, in some embodiments of the present disclosure, a certain amount of water is first added to the starch. The reason for adding water is as follows:

After the puffing, the starch produces two effects that are significantly different from the commercial starch:

First, the existence state of the starch has changed: after puffing with a puffing machine, the starch changes from a powdery to porous and fluffy block. Compared with powder, the fluffy and porous form (starch puffing body) is highly conducive to the drying of the starch.

Second, the structure of the starch has changed: some data reveal that starch granules are composed of a crystallization region and an amorphous region. The applicant have found that when the starch is used in the plastic field, the two regions have different influences on the properties of the final starch product.

The amorphous region, due to its disordered arrangement, is beneficial to the plasticization process of the starch and the plasticity of products. As for the crystallization region, due to the existence of crystals, it is not conducive to the plasticization processing of the starch. From a technological perspective, reducing the content of the crystallization region in starch granules will facilitate the plasticization processing of the starch. Based on this, when starch is puffed, under the high temperature and high pressure of the puffing machine and the plasticizing action of water as a plasticizer, the crystalline structure inside the starch granules is broken, which prompts the starch to change from a crystalline state to an amorphous state. When the starch under this condition exits the puffing machine through the die opening, water acts as a puffing agent, and puffs the starch into porous and loose solid blocks. After analysis, the internal structure of the solid blocks is still in an amorphous state. In short, the internal structure of the starch after puffing can undergo changes that are different from the original starch, which greatly improves the performance of the final product during plasticization and molding.

The starch is dried in a puffed state, which can overcome the shortcomings of existing technology and easily reduce the moisture content in the starch to not greater than 3%, 1.5%, 1%, or even 0.5%. The reason why the starch puffing body is easy to dry is as follows: 1. As mentioned above, the starch may exist in the form of fluffy, porous lumps after exiting the puffing machine. Compared with powdered starch, this form can help evaporate the moisture in the starch and help to deeply dry the starch by relying on existing drying methods. 2. The applicant has found in research that water exists in two states in the starch: one is free water, and there is a loose combination between the free water and starch molecules. During drying, the free water can be more easily dried out of the starch. The other one is bound water, which is characterized by a fixed hydrate formed by combination of water and starch molecules in the form of a hydrogen bond. When ordinary starch is dried, the bound water is difficult to separate from the starch due to the effect of the hydrogen bond unless large amounts of additional energy are expended. When the moisture content in existing starch is reduced to 13%, it is difficult to continue to remove water due to the influence of the bound water. The applicant has further found that the bound water mainly exists in the crystallization region of the starch granules, while the free water mainly exists in the amorphous region. When the starch is extruded and heated in a puffing machine, the crystalline state of its crystalline part transforms into an amorphous form. In this way, the bound water is converted into free water, which can be easily removed from the starch by existing drying means. This is also a key mechanism of the solutions of the present disclosure. In addition, when the amorphous starch and the moisture contained therein pass through the die of the puffing machine, a part of the moisture can instantly transform into gas under the action of high temperature and high pressure, and then evaporate instead of continuing to exist in the starch. At the same time, when the moisture changes from liquid to gas, the starch expands, and transforms into a porous and fluffy solid block form, both inside and outside. This form is very easy to remove the moisture in this solid block form after drying. As a result, although moisture is added to the starch at the beginning of processing, it is easier to remove the moisture from the starch through extrusion, puffing, and drying. Furthermore, the drying operations for starch in a block form are simpler, and compared with ordinary starch in a powder form, starch blocks are less likely to catch fire and even less likely to cause dust explosions during drying.

In the present disclosure, the pulverization of the starch puffing body is a common technical means, such as pulverizing the starch puffing body in a crusher or a flour machine. If the dry starch requires a smaller particle size, the dry starch may be pulverized in an ultrafine grinder.

### II. The Dry Starch is a Novel Applied Material.

The internal organizational structure of commercial starch granules is divided into a crystallization region and an amorphous region, which has a semi-crystalline nature. Under a polarizing microscope, the Maltese cross extinction phenomenon can be clearly seen in the commercial starch, that is, there are crystallization regions in the commercial starch granules. In addition, the amorphous part of starch is easily compatible with water, thus forming a colloid with water; however, it is difficult for water to invade the crystallization region, so that the crystallization region in starch still exists in its original form in water, resulting in the insolubility of starch in water. The commercial starch generally exists in the form of a suspension when being placed in water and may settle in a relatively short period of time.

However, no Maltese cross extinction phenomenon is observed in the dry starch under a polarizing microscope, indicating that the crystalline state in the internal structure of the dry starch disappears and transforms into an amorphous state. Furthermore, X-ray diffraction (XRD) patterns of commercial starch and dry starch are compared: the dry starch has a diffraction peak that is significantly weaker than that of the commercial starch, and the diffraction peak of the dry starch is broader. In addition, experiments have shown that the dry starch can quickly dissolve in water to form a colloidal solution, while most of ordinary starch is insoluble in water and forms a suspension.

The dry starch can be made into fine granules, or into small flakes, blocks, and strips. Currently, there are no dry starch products on the market for sale, and there is no description of the concept of dry starch in the prior art.

The use of the dry starch in the field of biodegradable plastics is reflected in the present disclosure by direct melt-mixing of the dry starch with a plastic masterbatch in the, thereby preparing a starch-based biodegradable material. This technical route is different from existing technology. Moreover, the performance of starch-based biodegradable material products under this technical route is also related to the particle size of the dry starch. A smaller particle size means better mechanical performance of the product, so the particle size of the dry starch is preferably greater than 100 mesh. The current technical route for applying starch to bio-based plastics is as follows: the starch is plasticized with a plasticizer to prepare a PLS, and the PLS is then fused with a plastic masterbatch to form the product. This technical route does not require moisture in starch, since the moisture is an excellent plasticizer for starch. The existing technical route also does not impose any requirements on the particle size of the starch.

In addition, as a new type of applied material, in addition to being used in the field of biodegradable plastics, the dry starch provided by the present disclosure can also be used in other fields, such as an auxiliary material for dairy products in the food industry. Compared with the commercial starch, the dry starch shows desirable instant solubility and low water content. The dry starch is also used as a tablet excipient in the pharmaceutical industry, exhibiting less interference with drug ingredients and a long shelf life due to the low moisture content; and there are similar applications of the dry starch in other fields.

In addition to the methods mentioned above, applicant have found that the dry starch can also be produced through the following approaches:

### 1. Microwave Drying

The applicant have found through experiments that microwaves can not only easily dry the free water in the amorphous region of the starch granules, but also dry the bound water in the crystallization region inside the starch granules. Due to their directional penetration energy, microwaves can directly act on the water molecules in the crystallization region and excite the water molecules, thereby breaking away from the constraint of the hydrogen bond on the water molecules and releasing the water molecules from the interior of the starch to achieve the purpose of drying. Commonly-used microwave heating equipment mainly includes box-type microwave heaters and tunnel-type microwave heaters, and commonly-used microwave frequencies are 915 MHz and 2,450 MHz. Microwave drying shows a rapid and desirable drying effect. For example, 200 g of the commercial starch can be dried to a moisture content of 2.1% within 10 min in a household microwave heater.

When the moisture content of microwave-dried starch is below 5%, the Maltese cross extinction phenomenon also disappears under a polarizing microscope, indicating that the crystalline structure in the starch is destroyed and the crystalline state is transformed into an amorphous form. The dry starch after microwave drying can also be dissolved in water, but its solubility and dissolution speed are significantly worse than those of the puffed dry starch.

### 2. Deep Drying on Commercial Pregelatinized Starch

There are two methods for pregelatinizing starch. A physical method includes the following steps: mixing an original starch with a certain amount of water and heating to obtain starch granules, subjecting the starch granules to swelling and gelatinization, then removing a moisture quickly by drying to obtain a pregelatinized starch. A chemical method includes the following steps: stirring an original starch to uniformity in an alkali solution having a certain pH value to obtain starch granules, subjecting the starch granules to swelling and gelatinization, then removing a moisture quickly by drying to obtain an alkaline pregelatinized starch.

The production processes commonly used in industry to prepare the pregelatinized starch specifically include: drum drying, spray drying, extrusion, and pulse jet. The commercial pregelatinized starch has a moisture content of approximately 10% to 14%.

The dry starch can also be obtained by drying the pregelatinized starch at a temperature of 100° C. to 150° C. using conventional drying methods, such as dryer drying, fluidized bed drying, and vacuum drying.

For commercial pregelatinized starch, the Maltese cross extinction phenomenon can also be observed under a polarizing microscope. The applicant believes that due to the high moisture content of pregelatinized starch, a part of the moisture also participates in the construction of crystals inside the starch granules. However, when the pregelatinized starch is dried to less than 5%, the Maltese cross extinction phenomenon disappears under a polarizing microscope, indicating that the crystalline state in the starch changes to an amorphous state at this time. This also proves that water plays an important role in the construction of starch crystals; both pregelatinized starch and dry starch can dissolve in water to form colloids, but dry starch has a greater affinity for water than that of pregelatinized starch.

The water solubility of dry starch is also different from that of pregelatinized starch. The moisture content of dry starch is low, and its affinity with water is significantly increased. When a certain amount of dry starch is added to water, the external starch reacts quickly with the water, and the starch forms a protective layer in the water, causing the starch to float on the water in the form of a ball. After opening the protective layer, the starch inside is still dry, powdery dry starch. The finer the particle size of the dry starch, the more obvious the above phenomenon is. For the dry starch, a strong external mechanical force is required to break and dissolve the starch clusters. For commercial pregelatinized starch, when the particle size reaches a certain fineness, starch agglomeration also occurs in water, but the starch clusters may settle into the water in a relatively short period of time. There is no dry powdery starch in the starch agglomeration.

3. Heat-Drying the Commercial Starch while Providing the Same with Withstanding Extrusion Force and Shearing Force.

As mentioned above, the applicant believes that the bound water in starch mainly exists in the crystallization region of the starch granules, while the free water mainly exists in the amorphous region of the starch granules. When the crystallization region of starch is broken and destroyed, the bound water in the original crystallization region can be changed into free water, and the free water can be easily removed from the starch granules. Experiments have shown that the crystallization regions inside the starch granules can be broken by extruding and shearing the starch. The specific means can be: two rollers contact and rotate at unequal speed, which can extrude and shear the starch between the rollers; meshing between gears, racks or threads can extrude and shear the starch between the tooth surfaces. The starch between the contact surface of the stator and the mover can be extruded and sheared. The starch is heated while undergoing extrusion and shearing, and the moisture therein is easily removed. Existing equipment such as kneaders, mixers, internal mixers, and extruders can provide the above extrusion force and shearing force, and therefore can be used as starch drying equipment in the present disclosure.

The following table shows the conditions of drying the commercial starch in a dryer (a) and in an internal mixer (b) (both drying at 110° C.):

TABLE 5

| Time (min) | 0 | 15 | 20 | 30 | 40 | 70 |
|---|---|---|---|---|---|---|
| Moisture content of a % | 13.15 | 10.67 | 8.21 | 6.34 | 5.27 | 3.41 |
| Moisture content of b % | 13.15 | 6.21 | 4.16 | 3.23 | 1.97 | 1.22 |

As shown in the table, after the commercial starch has been refined in the internal mixer, and the crystalline structure in the starch granules is broken, so that the moisture can be deeply removed and reduced to less than 5% to obtain the dry starch.

When the dry starch is observed under a polarizing microscope, the Maltese cross extinction phenomenon also disappears, indicating that the dry starch can also dissolve in water and form a colloid.

The following is a further description and explanation of the relevant terms and content in each technical solution:

### 1. Semi-Wet Starch

Semi-wet starch is a starch to which the moisture content of commercial starch (also called ordinary starch) is added to a certain value exceeding its normal moisture content (about 13%). The theoretical basis for the amount of water added has been explained previously, and the appropriate amount should be selected based on the puffing process. If a puffing machine works at higher speeds, the moisture content of the semi-wet starch can be lower, such as not greater than 18%, but it is best not to be below 15%. If a puffing machine works at lower speeds, the moisture content of the semi-wet starch can be higher. For example, if the puffing machine works at 50 r/h and the moisture content of the semi-wet starch reaches 30%, the puffing can still be conducted in a single-screw extruder. A method of adding water to the starch is a conventional method, including: agitated mixing, that is, adding starch and an appropriate amount of water into a stirring kettle for agitated mixing; spray mixing, wherein starch is spread out, and moisture is added to the starch in the form of a spray; and other mixing methods.

### 2. Wet Starch

The wet starch is derived from a production process of the commercial starch. At present, starch production in China and the United States mainly adopts wet grinding technology, referring to “Corn Starch Engineering Technology” published by China Light Industry Press and edited by BAI Kun. In it, the dehydration link in the production process is described as follows: a starch is separated by a scraper centrifuge to obtain a wet starch and a filtrate, wherein the wet starch has a moisture content of approximately 38%; and the drying link is described as follows: the wet starch enters a drying tube in an airflow drying system, and the moisture inside and outside starch granules is removed to obtain a commercial starch, wherein the commercial starch has a moisture content of less than or equal to 14%. The wet starch involved in the present disclosure refers to the wet starch described in the process. The semi-wet starch can also be selected from the production link of commercial starch: when entering the airflow drying system for drying, the wet starch does not need to be dried to a moisture content of less than or equal to 14% but only to a moisture content of 15% to 30%. This can not only reduce drying costs, but also allow the semi-wet starch to be used directly the present disclosure.

### 3. Starch Puffing Body

The starch puffing body is a starch obtained by puffing a semi-wet starch through a puffing machine. The puffing machine may be a single-screw, twin-screw, or three-screw extruder with heating configuration and is a common device used in the food and feed fields.

Compared with other extruders used in the plastics field, the rotational speed of the puffing machine is slightly higher, with a rough range of 20 rpm to 200 rpm, or higher. The selection of the puffing machine is related to the puffing pressure and the die size required by the process, as well as other parameters of the puffing machine. As disclosed in patent CN1049271A, the puffing machine has a shaft speed of 30 rpm to 100 rpm.

The working temperature of the puffing machine must meet the requirements of the puffing, and is generally higher than 110° C. The shape of the starch puffing body can be in its original shape extruded by the puffing machine, such as long strip, and pellets, etc, or can be properly crushed (preferably pre-dried, such as blow-dried by a fan, until the moisture content is less than 15%), into small pieces, chunks, or powders. However, from the perspective of drying convenience in step (3), it is best not to grind the starch puffing body into too fine powder, such as greater than 100 mesh. In an embodiment of the present disclosure, a particle size of the powdery starch puffing body is required to be not less than 0.1 mm.

The concept of the dry starch has been described previously. Different from the powdery form of ordinary starch, the appearance of the starch puffing body is solid, in the form of strips, blocks, or granules, etc. Therefore, more flexible drying modes, such as hot air drying, can be used for drying the starch puffing body, which is also a drying mode that cannot be adopted for ordinary starch. The hot air is derived from a hot air fan. From an efficiency perspective, a higher temperature of the hot air is better. However, if the temperature of the hot air exceeds 170° C., the starch turns yellow; and if the temperature of the hot air is too cold, such as below 20° C., the drying may have poor effect and extremely low efficiency. Therefore, the temperature of the hot air is at suitably 80° C. to 150° C., preferably 110° C. to 130° C. Other modes such as oven drying, vacuum drying, and microwave drying are also fully applicable to the drying of starch puffing body. Moreover, when these drying modes are adopted, since the starch puffing body has a porous and fluffy shape compared to ordinary starch, the moisture in the starch is easier to volatilize and remove. Among them, hot air drying, oven drying, and vacuum drying are all conventional operating methods.

Table 6 shows the drying data (drying time and moisture content) of the corn commercial starch and its starch puffing body 1 and starch puffing body 2 in the same dryer; wherein the starch puffing body 1 has a particle size of 0.1 mm to 0.5 mm, the starch puffing body 2 has a particle size of 1 mm to 2 mm. a starting mass is 100 g, the dryer works at 130° C.; and the moisture content of starch is in mass percentage (%).

TABLE 6

| Time (min) | 0 | 20 | 30 | 40 | 70 | 100+ |
|---|---|---|---|---|---|---|
| Commercial starch | 13.15 | 8.39 | 6.41 | 5.36 | 2.31 | 2.1 |
| Starch puffing | 14.32 | 3.58 | 1.21 | 0.76 | 0.54 | 0.33 |
| body 1 | | | | | | |
| Starch puffing | 15.68 | 3.23 | 0.96 | 0.63 | 0.49 | 0.31 |
| body 2 | | | | | | |

As shown in the experimental data in Table 6, ordinary starch can hardly be dried to a moisture content of less than 2%, and also highly difficult to a moisture content of less than 3%. For both types of starch puffing body, they are easily dried to a moisture content of not greater than 2% within 30 min, and then to a moisture content of not greater than 1% within 40 min. In addition, Table 1 also shows that when drying to less than 5%, the energy consumption of commercial starch is 2 times higher that of the starch puffing body. This indicates that compared with commercial starch, the starch puffing body is easier to dry thoroughly, saving time and energy. In addition, for the starch puffing body 1 and starch puffing body 2, the small particle size makes the drying relatively difficult, so the particle size of the starch puffing body is not likely to be too low during the drying.

In the present disclosure, the dry starch is a new type of applied material. Compared with commercial starch, which is not easy to remove moisture, the dry starch provided by the present disclosure can remove moisture thoroughly, with a removal method that is highly efficient and consumes little energy. The starch-based plastic products prepared from the dry starch have desirable mechanical performance. In addition to the field of biodegradable plastics, the dry starch can replace commercial starch to be used in many fields, with performance better than that of the commercial starch.

### DETAILED DESCRIPTION OF THE EMBODIMENTS

### Example 1

5,000 g of a starch (commercial starch, having a moisture content of 13.4 wt %) and 420 g of water were mixed in a high-speed mixer for 10 min, obtaining a mixture. The mixture was continuously added into a puffing machine, wherein the puffing machine was a twin-screw extruder with a screw diameter of 35 mm, a rotational speed of 150 r/min, three heating zones with temperature settings of 90° C., 120° C., and 120° C., and a die diameter of 3 mm. The mixture was extruded, heated, and puffed by the puffing machine, obtaining a starch puffing body. There was a hot air fan provided after the puffing procedure. The hot air fan was purchased from the market and an air outlet temperature of the hot air fan was set at 130° C. The starch puffing body coming out of the die was immediately dried by the hot air fan, obtaining a dried starch puffing body. After 10 min, a moisture content of the dried starch puffing body was measured to be 1.54%. The dried starch puffing body was crushed into small flakes, and then pulverized in a jet mill for 20 min, obtaining a dry starch. The dry starch has a mesh number of 150 mesh to 200 mesh.

### Example 2

5,000 g of a starch from a corn starch factory was purchased. After detection, the starch has a moisture content of 13.2 wt %. A feed inlet of a puffing machine was additionally provided with a water inlet. Water was introduced into the feed inlet through the water inlet. The starch and water were continuously added into the puffing machine at the same time according to a ratio of the starch to water of 7:1 (mass ratio), obtaining a mixture. The puffing machine was a twin-screw extruder with a screw diameter of 35 mm, a rotational speed of 150 r/min, three heating zones with temperature settings of 90° C., 120° C., and 120° C., and a die diameter of 3 mm. The mixture was extruded, heated, and puffed by the puffing machine, obtaining a starch puffing body. The starch puffing body was pre-dried by an air blower, obtaining a pre-dried starch puffing body. A moisture content of the pre-dried starch puffing body was measured to be 7.3%. Then the pre-dried starch puffing body was crushed into small flakes with a crusher and placed in an electric oven set at 120° C. for drying, obtaining a dried starch puffing body. After 20 min, a moisture content of the dried starch puffing body was measured to be 1.06%. Then the dried starch puffing body was pulverized in a jet mill for 30 min, obtaining a dry starch. The dry starch has a mesh number of 250 mesh.

### Example 3

A semi-wet starch having a moisture content of 20% was customized from a certain starch factory. 5 kg of the semi-wet starch was continuously added into a puffing machine, wherein the puffing machine was a twin-screw with a screw diameter of 35 mm, a rotational speed of 150 r/min, three heating zones with temperature settings of 90° C., 130° C., and 120° C., and a die diameter of 1 mm. The semi-wet starch was extruded, heated, and puffed by the puffing machine, obtaining a starch puffing body. There was a hot air fan provided after the puffing procedure. The hot air fan was purchased from the market and an air outlet temperature of the hot air fan was set at 130° C. The starch puffing body coming out of the die was immediately dried by the hot air fan, obtaining a dried starch puffing body. After 15 min, a moisture content of the dried starch puffing body was measured to be 0.93%. The dried starch puffing body was crushed into small flakes, and then pulverized in a jet mill for 15 min, obtaining a dry starch. The dry starch has a mesh number of 180 mesh.

### Example 4

A wet starch having a moisture content of 37.4% was purchased from a certain starch factory. 5 kg of the wet starch was placed in a dryer for drying, and taken out when its moisture content reached 20%, obtaining a semi-wet starch. Then the semi-wet starch was continuously added into a puffing machine, wherein the puffing machine was a twin-screw with a screw diameter of 35 mm, a rotational speed of 150 r/min, three heating zones with temperature settings of 90° C., 130° C., and 120° C., and a die diameter of 1 mm. The semi-wet starch was extruded, heated, and puffed by the puffing machine, obtaining a starch puffing body. There was a hot air fan provided after the puffing procedure. The hot air fan was purchased from the market and an air outlet temperature of the hot air fan was set at 130° C. The starch puffing body coming out of the die was immediately dried by the hot air fan, obtaining a dried starch puffing body. After 15 min, a moisture content of the dried starch puffing body was measured to be 0.93%. The dried starch puffing body was crushed into small flakes, and then pulverized in a jet mill for 30 min, obtaining a dry starch. The dry starch has a mesh number of 250 mesh.

### Example 5

5,000 g of a starch (commercial starch, having a moisture content of 13.4 wt %) and 420 g of water were mixed in a high-speed mixer for 10 min, obtaining a mixture. The mixture was continuously added into a puffing machine, wherein the puffing machine was a twin-screw extruder with a screw diameter of 35 mm, a rotational speed of 150 r/min, three heating zones with temperature settings of 90° C., 120° C., and 120° C., and a die diameter of 3 mm. The mixture was extruded, heated, and puffed by the puffing machine, obtaining a starch puffing body. After detection, the starch puffing body had a moisture content of 8.2%. The starch puffing body was crushed into small flakes, and then pulverized in a jet mill for 20 min, obtaining a dry starch. The dry starch has a mesh number of 90 mesh. The dry starch was dried in a fluidized bed dryer for 20 min, and a moisture content of the resulting dry starch was measured to be 3.27%.

### Example 6

2,000 g of the dry starch obtained in Example 1 was taken and added with 3,000 g of linear polyethylene (LPE), and 200 g of paraffin into a molding machine simultaneously, obtaining a mixture, wherein the molding machine was an experimental extruder, with heating temperatures of 80° C., 130° C., and 135° C., and die sizes of 1 mm and 30 mm. The mixture was extruded, obtaining a starch-based PE sheet. The sheet has a tensile strength of 14.2 MPa and an elongation of 246%.

### Example 7

2,000 g of the dry starch obtained in Example 1 was taken and added with 8,000 g of PBAT simultaneously into a granulating extrude with heating temperatures of 80° C., 130° C., and 135° C. and a die diameter of 3 mm. The resulting system was subjected to extrusion, and the obtained product was granulated in a granulator, obtaining a starch-based biodegradable masterbatch.

The granulation was interrupted, and a material with a length of 200 mm was taken and then cooled. The tensile strength and elongation of the material were measured in a tensile testing machine as 23 MPa and 217%, respectively.

### Example 8

5,000 g of a starch (commercial starch, having a moisture content of 13.4 wt %) and 420 g of water were mixed in a high-speed mixer for 10 min, obtaining a semi-wet starch. The semi-wet starch was continuously added into a puffing machine, wherein the puffing machine was a twin-screw with a screw diameter of 35 mm, a rotational speed of 150 r/min, three heating zones with temperature settings of 90° C., 120° C., and 120° C., and a die diameter of 3 mm. The semi-wet starch was extruded, heated, and puffed by the puffing machine, obtaining a starch puffing body. The starch puffing body was pre-dried by an air blower, obtaining pre-dried starch puffing body. A moisture content of the pre-dried starch puffing body was measured to be in a range of 10.5% to 12.5%. Then the pre-dried starch puffing body was crushed into small flakes of 0.1 mm to 1 mm length with a crusher. 250 g of the small flakes were taken and placed in an electric oven set at 120° C. for drying, obtaining a dried starch puffing body. After 40 min, a moisture content of 8.87 g of the dried starch puffing body was measured to be 0.76% by a moisture content tester. A dry starch was obtained.

The dry starch has no birefringence cross extinction phenomenon under a polarizing microscope, and the dry starch could be dissolved in water and form a colloid with water.

### Example 9

5,000 g of a starch (commercial starch, having a moisture content of 13.4 wt %) and 420 g of water were mixed in a high-speed mixer for 10 min, obtaining a semi-wet starch. The semi-wet starch was continuously added into a puffing machine, wherein the puffing machine was a twin-screw with a screw diameter of 35 mm, a rotational speed of 150 r/min, three heating zones with temperature settings of 90° C., 120° C., and 120° C., and a die diameter of 3 mm. The semi-wet starch was extruded, heated, and puffed by the puffing machine, obtaining a starch puffing body. There was a hot air fan provided after the puffing procedure. An air outlet temperature of the hot air fan was set at 150° C. The starch puffing body coming out of the die was immediately dried by the hot air fan for 10 min, obtaining a dry starch. A moisture content of the dry starch was measured to be 1.54%.

The dry starch has no birefringence cross extinction phenomenon under a polarizing microscope, and the dry starch could be dissolved in water and form a colloid with water.

Compared with Example 8, this example consumed less time to obtain the dry starch.

### Example 10

5,000 g of a starch from a corn starch factory was purchased. After detection, the starch has a moisture content of 13.2 wt %. A feed inlet of a puffing machine (extruder) was additionally provided with a water inlet. Water flowed into a feed inlet through the water inlet. The starch and water were continuously added to the puffing machine at the same time according to a ratio of the starch to water of 7:1 (mass ratio), obtaining a mixture. The puffing machine was a twin-screw extruder with a screw diameter of 35 mm, a rotational speed of 150 r/min, three heating zones with temperature settings of 90° C., 120° C., and 120° C., and a die diameter of 3 mm. The mixture was extruded, heated, and puffed by the puffing machine, obtaining a starch puffing body. The starch puffing body was pre-dried by a blower, obtaining a pre-dried starch puffing body. A moisture content of the pre-dried starch puffing body was measured to be in a range of 11.3% to 11.8%. Then the pre-dried starch puffing body was crushed into small flakes of 0.1 mm to 1 mm length with a crusher. 250 g of the small flakes were taken and placed in an electric oven set at 120° C. for drying. After 40 min, a moisture content of the dried starch puffing body was measured to be 0.54%. A dry starch was obtained.

The dry starch has no birefringence cross extinction phenomenon under a polarizing microscope, and the dry starch could be dissolved in water and form a colloid with water.

### Example 11

5,000 g of a starch from a corn starch factory was purchased. After detection, the starch had a moisture content of 13.2 wt %. A feed inlet of a puffing machine (extruder) was additionally provided with a water inlet. Water flowed into a feed inlet through the water inlet. The starch and water were continuously added to the puffing machine at the same time according to a ratio of the starch to water of 7:1 (mass ratio), obtaining a wet starch. The puffing machine was a twin-screw extruder with a screw diameter of 35 mm, a rotational speed of 150 r/min, three heating zones with temperature settings of 90° C., 120° C., and 120° C., and a die diameter of 3 mm. The wet starch was extruded, heated, and puffed by the puffing machine, obtaining a starch puffing body. There was a hot air fan provided after the puffing procedure. An air outlet temperature of the hot air fan was set at 150° C. The starch puffing body coming out of the die was immediately dried by the hot air fan for 10 min, obtaining a dry starch. A moisture content of the dry starch was measured to be 1.09%.

The dry starch has no birefringence cross extinction phenomenon under a polarizing microscope, and the dry starch could be dissolved in water and form a colloid with water.

Compared with Example 10, this example consumed less time to obtain the dry starch.

### Example 12

A semi-wet starch having a moisture content of 20% was customized from a certain starch factory. 5 kg of the semi-wet starch was continuously added into a puffing machine, wherein the puffing machine was a twin-screw with a screw diameter of 35 mm, a rotational speed of 150 r/min, three heating zones with temperature settings of 90° C., 130° C., and 120° C., and a die diameter of 1 mm. The semi-wet starch was extruded, heated, and puffed by the puffing machine, obtaining a starch puffing body. The starch puffing body was pre-dried by an air blower, obtaining pre-dried starch puffing body. A moisture content of the pre-dried starch puffing body was measured to be 11.4%. Then the pre-dried starch puffing body was crushed into granules with a diameter of 0.5 mm to 2 mm with a crusher. 250 g of the granules were taken and placed in an electric oven set at 130° C. for drying, obtaining a dried starch puffing body. After 30 min, a moisture content of the dried starch puffing body was measured to be 0.82%. A dry starch was obtained.

The dry starch has no birefringence cross extinction phenomenon under a polarizing microscope, and the dry starch could be dissolved in water and form a colloid with water.

### Example 13

A semi-wet starch having a moisture content of 20% was customized from a certain starch factory. 5 kg of the semi-wet starch was continuously added into a puffing machine, wherein the puffing machine was a twin-screw with a screw diameter of 35 mm, a rotational speed of 150 r/min, three heating zones with temperature settings of 90° C., 130° C., and 120° C., and a die diameter of 1 mm. The semi-wet starch was extruded, heated, and puffed by the puffing machine to, obtaining a starch puffing body. There was a hot air fan provided after the puffing procedure. An air outlet temperature of the hot air fan was set at 150° C. The starch puffing body coming out of the die was immediately dried by the hot air fan for 6 min, obtaining a dry starch. A moisture content of the dry starch was measured to be 1.47%.

The dry starch has no birefringence cross extinction phenomenon under a polarizing microscope, and the dry starch could be dissolved in water and form a colloid with water.

Compared with Example 12, this example consumed less time to obtain the dry starch.

### Example 14

A wet starch having a moisture content of 37.4% was purchased from a certain starch factory. 5 kg of the wet starch was placed in a dryer for drying, and taken out when its moisture content reached 20%, obtaining a semi-wet starch. Then the semi-wet starch was continuously added into a puffing machine, wherein the puffing machine was a twin-screw with a screw diameter of 35 mm, a rotational speed of 150 r/min, three heating zones with temperature settings of 90° C., 130° C., and 120° C., and a die diameter of 1 mm. The semi-wet starch was extruded, heated, and puffed by the puffing machine, obtaining a starch puffing body. The starch puffing body was pre-dried by an air blower, obtaining pre-dried starch puffing body. A moisture content of the pre-dried starch puffing body was measured to be 12.6%. Then the pre-dried starch puffing body was crushed into granules with a diameter of 0.5 mm to 2 mm with a crusher. 250 g of the granules were taken and placed in an electric oven set at 130° C. for drying, obtaining a dried starch puffing body. After 30 min, a moisture content of the dried starch puffing body was measured to be 0.67%. A dry starch was obtained.

The dry starch has no birefringence cross extinction phenomenon under a polarizing microscope, and the dry starch could be dissolved in water and form a colloid with water.

### Example 15

200 g of a commercial corn starch (having a moisture content of 13.2%) was placed into an experimental internal mixer, wherein parameters of the internal mixer included: capacity, 1 L, temperature range: normal temperature to 300° C.; heating: electric heating tube; heating power: 2.4 KW, rotor speed ratio 1:(1.27-1.4); flip angle 110°, rotor speed: 0 rpm to 85 rpm. The internal mixer was set to a heating temperature of 110° C. and a rotational speed of 50 rpm, and was further equipped with an exhaust port. After internal mixing for 30 min, a dry starch was obtained after discharging, and a moisture content of the dry starch was measured to be 3.2%.

The dry starch has no birefringence cross extinction phenomenon under a polarizing microscope, and the dry starch could be dissolved in water and form a colloid with water.

### Example 16

200 g of a commercial pregelatinized corn starch (having a moisture content of 11.7%, and a 50-mesh screen pass rate of 23.6%) was placed in a test dryer for drying. The drying was conducted at 120° C. After 30 min, a moisture content of the dried starch was measured to be 3.6%, and a dry starch was obtained. The dry starch was ground in a ball mill for 0.5 h, and had a pass rate in the 180-mesh screen of 91%.

The dry starch has no birefringence cross extinction phenomenon under a polarizing microscope, and the dry starch was put into water and formed agglomerates on the surface of water. After opening the agglomerates, the starch inside was still powdery.

### Example 17

200 g of a commercial starch (having a moisture content of 13.2%, and a 100-mesh screen pass rate of 68%) was placed in a microwave oven for drying. The drying was conducted at a microwave frequency of 2,450 MHz. After drying for 10 min, a moisture content of the dried starch was measured to be 1.37%, and a dry starch was obtained. The dry starch was pulverized in a jet mill, and taken out after 15 min, and had a pass rate in the 300-mesh screen of 79%.

The dry starch has no birefringence cross extinction phenomenon under a polarizing microscope, and the dry starch was put into water and formed agglomerates on the surface of water. After opening the agglomerates, the starch inside was still powdery.

### Example 18

The dry starch prepared in Example 9 was taken out and pulverized to greater than 300 mesh in a jet mill. Then 200 g of the dry starch was mixed with and 800 g of a PBAT plastic masterbatch in a mixer to even, obtaining a mixture. Then the mixture was evenly added into a test extruder, wherein parameters for the test extruder included: a single screw of 35 mm, a rotational speed of 10 rpm, three heating zones with heating temperatures of 140° C., 130° C., and 80° C., and a die diameter of 1 mm. An extruded material was cooled and pelletized by a pelletizer, obtaining a granular starch-based plastic masterbatch.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

1. A dry starch used in a field of biodegradable plastics, wherein the dry starch is prepared by removing moisture from a commercial starch; the dry starch has a moisture content of not greater than 5 wt %; and starch granules have an internal organizational structure mainly in an amorphous form.

2. The dry starch of claim 1, wherein the dry starch is prepared by drying a commercial pregelatinized starch to a moisture content of not greater than 5 wt %.

3. The dry starch of claim 1, wherein the dry starch is prepared by drying the commercial starch in a microwave dryer to a moisture content of not greater than 5 wt %.

4. The dry starch of claim 1, wherein the dry starch is prepared by subjecting the commercial starch to heat-drying under extrusion and shearing in a device capable of providing an extrusion force and a shearing force to a moisture content of not greater than 5 wt %.

5. The dry starch of claim 1, wherein the dry starch has a moisture content of not greater than 3 wt %.

6. A method for preparing a dry starch used in a field of biodegradable plastics, comprising:
step (1) mixing water with a starch to obtain a mixture, an amount of the water added meeting that a moisture content accounts for between 15 wt % and 30 wt % of a total weight of the mixture;
step (2) puffing the mixture obtained in step (1) with a puffing machine to obtain a starch puffing body;
step (3) drying the starch puffing body to a moisture content of less than 6 wt % to obtain a dried starch puffing body; and
step (4) crushing the dried starch puffing body obtained in step (3) into a powder having a fineness degree of not less than 80 mesh to obtain the dry starch.

7. (canceled)

8. A method for preparing a dry starch used in a field of biodegradable plastics, comprising:
step (1) taking a semi-wet starch with a moisture content of between 15 wt % and 30 wt % from a wet-grinding starch-processing procedure;
step (2) puffing the semi-wet starch in a puffing machine to obtain a starch puffing body;
step (3) drying the starch puffing body to a moisture content of less than 6 wt % to obtain a dried starch puffing body; and
step (4) crushing the dried starch puffing body obtained in step (3) into a powder having a fineness degree of not less than 80 mesh to obtain the dry starch.

9. (canceled)

10. The method of claim 6, wherein step (3) is interchanged with step (4), such that the starch puffing body is crushed into a starch powder having a fineness degree of not less than 80 mesh and then the starch powder is dried to a moisture content of less than 6 wt %.

11. The method of claim 10, wherein the dry starch has a moisture content of not greater than 5 wt % and a particle size of greater than 100 mesh.

12. The method of claim 6, wherein the drying in step (3) is conducted by hot air drying.

13. A dry starch prepared by the method of claim 6.

14. A method for using the dry starch of claim 1 in a field of biodegradable plastics.

15. The method of claim 14, comprising:
melt-mixing the dry starch with a plastic masterbatch in a granulator to obtain a starch-based plastic masterbatch,
wherein a mass percentage of the dry starch is between 3 wt % and 70 wt % without addition of a starch plasticizer.

16. The method of claim 14, comprising:
melt-mixing the dry starch with a plastic masterbatch in a molding machine to obtain a starch-based plastic product,
wherein a mass percentage of the dry starch is between 3 wt % and 70 wt % without addition of a starch plasticizer.

17. The dry starch of claim 2, wherein the dry starch has a moisture content of not greater than 3 wt %.

18. The dry starch of claim 3, wherein the dry starch has a moisture content of not greater than 3 wt %.

19. The dry starch of claim 4, wherein the dry starch has a moisture content of not greater than 3 wt %.

20. The method of claim 8, wherein step (3) is interchanged with step (4), such that the starch puffing body is crushed into a starch powder having a fineness degree of not less than 80 mesh and then the starch powder is dried to a moisture content of less than 6 wt %.

21. The method of claim 8, wherein the drying in step (3) is conducted by hot air drying.
